(19) United States
(12) Patent Application Publication
(10) Pub. No.: US 2013/0319109 A1
(43) Pub. Date: Dec. 5, 2013

(54) MATERIALS-TESTING MULTISENSOR AND METHOD FOR TESTING OF MATERIALS WITH A MATERIALS-TESTING MULTISENSOR

(71) Applicant: Frank Rinn, Heidelberg (DE)

(72) Inventor: Frank Rinn, Heidelberg (DE)

(21) Appl. No.: 13/857,722

(22) Filed: Apr. 5, 2013

(30) Foreign Application Priority Data
Apr. 7, 2012 (DE) 10 2012 006 911.1

(51) Int. Cl. G01N 9/36

(52) U.S. Cl. CPC G01N 9/36
USPC 73/32 R

(57) ABSTRACT

A material testing multisensor comprising at least one receiving sensor (1) with at least two pins (2), which are electrically conductive, preferably in the front region, can be driven with a defined force into a test piece to be investigated and, depending on their depth of penetration, allow the average density there to be concluded and, depending on the electrical conductivity between the pins (2), allow the ion content between them to be concluded, and also comprising at least one transmitter (3) or transmitter sensor, with which the test piece is tapped at at least one location, preferably at a number of locations, in the case of round cross sections for example seven evenly distributed locations, in order to measure and evaluate the sound transit time and other properties of the generated shockwaves at the receiving sensor (1). Also provided is a method for material testing with such a material testing multisensor.

### FIELD OF THE INVENTION

The invention relates to a material testing multisensor comprising at least one receiving sensor with at least two pins, which are electrically conductive, preferably in the front region, can be driven with a defined force into a test piece to be investigated and, depending on their depth of penetration, allow the average density there to be concluded and, depending on the electrical conductivity between the pins, allow the ion content between them to be concluded, and also comprising at least one transmitter or transmitter sensor, with which the test piece is tapped at at least one location, preferably at a number of locations, in the case of round cross sections for example seven evenly distributed locations, in order to measure and evaluate the sound transit time and other properties of the generated shockwaves at the receiving sensor. Also provided is a method for material testing with a material testing multisensor, the pins being driven with a defined force into a test piece to be investigated and, depending on their depth of penetration, the average density there being concluded and, depending on the electrical conductivity between the pins, the ion content between them being concluded.

### BACKGROUND OF THE INVENTION

Methods in which the transit time of shockwaves in wood is measured for assessing wood quality (modulus of elasticity) and the electrical conductivity between two steel pins is measured in order to establish the presence of possible rot or wood defects have been known since the 1960s or 1970s.

Since 1999, tomographic applications of the combination of these methods have been known, and in the meantime have also become established in the market. However, for many applications this tomography is too complex and laborious, since it usually needs several minutes, often an hour.

It has therefore not been possible so far to satisfy the conditions of some potential application areas for this technique. A measurement sometimes has to be performed in a few seconds, in some automated applications even within one second. This is impossible with the existing systems. An example is the rapid testing of the quality of wood in the head of so-called combine wood harvesters, where it has already been the case for several years that the measurement of the sound transit time is tested. However, the two-point transit time measurement alone only allows limited assessments to be made of the wood quality, and in particular of any damage that is possibly present.

### SUMMARY OF THE INVENTION

All of these restrictions are overcome by the material testing multisensor and method described here, according to claims 1 and 6.

Advantageous refinements are described in dependent claims 2 to 5.

The device according to the invention consists of at least one multisensor, a transmitter and optionally a central unit.

### BRIEF DESCRIPTION OF THE DRAWINGS

Having thus described embodiments of the invention in general terms, reference will now be made to the accompanying drawings, where:

FIG. 1 illustrates a multisensor system, in accordance with one embodiment of the invention; and

FIG. 2 illustrates two sensors, in accordance with one embodiment of the invention.

### DETAILED DESCRIPTION OF THE INVENTION

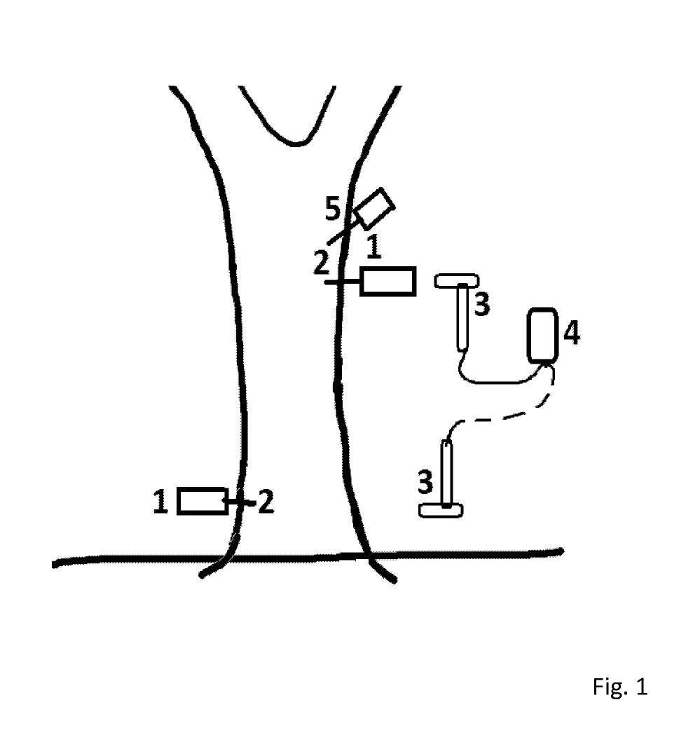

According to a preferred embodiment as shown in FIG. 1, the multisensor includes at least two pins (2), which are electrically conductive, preferably in the front region, can be driven with a defined force into a test piece to be investigated and, depending on their depth of penetration, allow the average density to be concluded and, depending on the electrical conductivity between the pins, allow the ion content between them to be concluded, which not only makes it possible to correct the density measurement, but also makes it possible to assess the moisture content of the wood and the presence of possible damage, for example caused by fungus, and a vibration or shockwave sensor (1) for measuring outgoing and incoming shockwaves, not only the transit times but also the pulse energy and the vibrating and decaying behavior being recorded.

By tapping at defined locations of the test piece, the transmitter (3) or transmitter sensor generates shockwaves, either directly or by way of pins/nails/screws or by way of a multisensor (1).

The multisensor optionally has a central data acquisition, setting and display device (4), which collects, analyzes, stores and displays the data measured.

In the simplest embodiment, the system consists of a multisensor (1), a transmitter (3) and a central unit (4), at which the positions of the multisensor (1) and the positions of the signal injection by means of the transmitter (3) are input and where the results are recorded, analyzed, stored and/or displayed.

In the smallest automated version, the system consists of two multisensors (1), which are automatically placed on the test piece and triggered one after the other, so that the first sensor can record and measure the shockwaves of the second. In this case, the conductivity between the different multisensors can also be measured, in order to be able to improve the correlation with the material properties and better detect internal defects.

Both of the multisensors may optionally be attached such that their pins enter the material perpendicularly or at a defined angle. In the case of measurements in the longitudinal direction of the trunk, greater correlations of the shockwave transit time with the modulus of elasticity are achieved for example at an angle of 45°.

In order to circumvent effects on conductivity of the bark, and consequently increase the accuracy, the pins (2) may be insulated in the rear part by means of an outer coating.

The transmission of the communication signals and measured values preferably takes place between the multisensors and the optional central unit by radio. In the case of a stationary system, a cable is advantageous, among other reasons because of the more reliable and faster connection.

Typical applications of the system are rapid tests on trees and palms, on the one hand with regard to internal damage (across the grain), on the other hand with respect to the quality of the wood (along the grain).

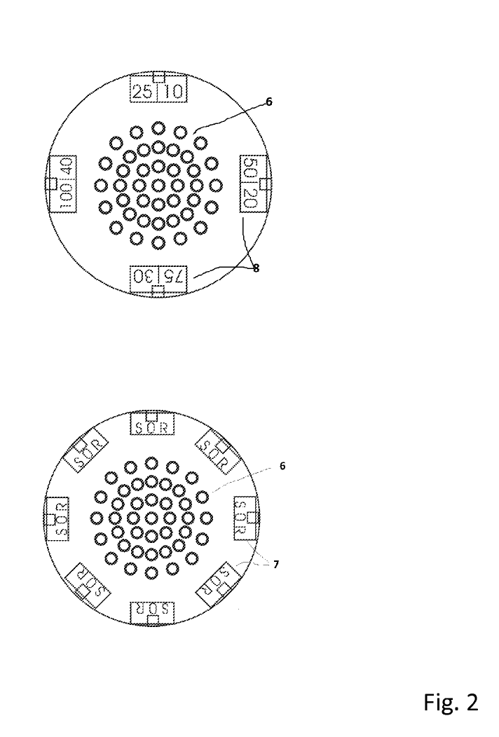

According to FIGS. 1 and 2, the central unit (4) preferably has a cylindrical form, which represents the trunk to be investigated or the wood to be investigated and displays the results for the corresponding cross section for example on a screen or by means of LEDs (6). For a quick and reliable presetting and assignment, the points to be measured can be preset there at switches (7). If measurements are to be performed in a number of planes, the setting and display elements may be arranged in a stacked manner, it being possible to arrange between the measuring planes, which respectively represent the height of a multisensor, spacing layers, at which in turn the spacing of the measuring planes can be set, for example by means of switches.

If many measurements are to be performed, for example in plantations of many trees or palms (or masts), a one-off setting of the measuring and tapping points makes a subsequent measurement at a rate of seconds per test piece possible, whereby the main objective of this procedure, that of rapid measurement, is achieved, while at the same time the combination of measurements (depth of penetration˜depth, electrical conductivity˜condition/moisture of wood) allows the respective meaningfulness to be enhanced considerably and the accuracy and reliability of the assessments to be increased correspondingly.

1. Material testing multisensor comprising at least one receiving sensor with at least two pins, which are electrically conductive, preferably in the front region, can be driven with a defined force into a test piece to be investigated and, depending on their depth of penetration, allow the average density there to be concluded and, depending on the electrical conductivity between the pins, allow the ion content between them to be concluded, and also comprising at least one transmitter or transmitter sensor, with which the test piece is tapped at at least one location, preferably at a number of locations, in the case of round cross sections for example seven evenly distributed locations, in order to measure and evaluate the sound transit time and other properties of the generated shockwaves at the receiving sensor.

2. Material testing multisensor according to claim 1, characterized in that a central unit for data recording, display, storage and/or output is connected to the transmitter or transmitter sensor.

3. Material testing multisensor according to claim 1, characterized in that the receiving sensor has a power storage unit or built-in power storage unit and sends its data by radio to a central unit, which is connected to the transmitter or transmitter sensor.

4. Material testing multisensor according to claim 2, characterized in that the positions of the pulse input are set on the central unit.

5. Material testing multisensor according to claim 1, characterized in that the positions of the pulse input are not at the same height, but are also longitudinally offset, or chosen to determine properties in the longitudinal direction.

6. Method for material testing with a material testing multisensor according to claim 1, the pins being driven with a defined force into a test piece to be investigated and, depending on their depth of penetration, the average density there being concluded and, depending on the electrical conductivity between the pins, the ion content between them being concluded.

7. Material testing multisensor according to claim 2, characterized in that the receiving sensor has a power storage unit or built-in power storage unit and sends its data by radio to a central unit, which is connected to the transmitter or transmitter sensor.

8. Material testing multisensor according to claim 3, characterized in that the positions of the pulse input are set on the central unit.

9. Material testing multisensor according to claim 2, characterized in that the positions of the pulse input are not at the same height, but are also longitudinally offset, or chosen to determine properties in the longitudinal direction.

10. Material testing multisensor according to claim 3, characterized in that the positions of the pulse input are not at the same height, but are also longitudinally offset, or chosen to determine properties in the longitudinal direction.

11. Material testing multisensor according to claim 7, characterized in that the positions of the pulse input are not at the same height, but are also longitudinally offset, or chosen to determine properties in the longitudinal direction.

12. Material testing multisensor according to claim 8, characterized in that the positions of the pulse input are not at the same height, but are also longitudinally offset, or chosen to determine properties in the longitudinal direction.

13. Method for material testing with a material testing multisensor according to claim 2, the pins being driven with a defined force into a test piece to be investigated and, depending on their depth of penetration, the average density there being concluded and, depending on the electrical conductivity between the pins, the ion content between them being concluded.

14. Method for material testing with a material testing multisensor according to claim 3, the pins being driven with a defined force into a test piece to be investigated and, depending on their depth of penetration, the average density there being concluded and, depending on the electrical conductivity between the pins, the ion content between them being concluded.

15. Method for material testing with a material testing multisensor according to claim 4, the pins being driven with a defined force into a test piece to be investigated and, depending on their depth of penetration, the average density there being concluded and, depending on the electrical conductivity between the pins, the ion content between them being concluded.

16. Method for material testing with a material testing multisensor according to claim 5, the pins being driven with a defined force into a test piece to be investigated and, depending on their depth of penetration, the average density there being concluded and, depending on the electrical conductivity between the pins, the ion content between them being concluded.

17. Method for material testing with a material testing multisensor according to claim 7, the pins being driven with a defined force into a test piece to be investigated and, depending on their depth of penetration, the average density there being concluded and, depending on the electrical conductivity between the pins, the ion content between them being concluded.

18. Method for material testing with a material testing multisensor according to claim 8, the pins being driven with a defined force into a test piece to be investigated and, depending on their depth of penetration, the average density there being concluded and, depending on the electrical conductivity between the pins, the ion content between them being concluded.

19. Method for material testing with a material testing multisensor according to claim 9, the pins being driven with a defined force into a test piece to be investigated and, depending on their depth of penetration, the average density there being concluded and, depending on the electrical conductivity between the pins, the ion content between them being concluded.

20. Method for material testing with a material testing multisensor according to claim 10, the pins being driven with a defined force into a test piece to be investigated and, depending on their depth of penetration, the average density there being concluded and, depending on the electrical conductivity between the pins, the ion content between them being concluded.
